(19) United States
(12) Patent Application Publication
(10) Pub. No.: US 2024/0391501 A1
(43) Pub. Date: Nov. 28, 2024

(54) VEHICLE REACTION TO SCENE CHANGES AT PICK-UP AND DROP-OFF

(71) Applicant: GM Cruise Holdings LLC, San Francisco, CA (US)

(72) Inventors: Ananya Sharan, Dublin, CA (US); Lucie Zikova, Boulder, CO (US)

(73) Assignee: GM Cruise Holdings LLC, San Francisco, CA (US)

(21) Appl. No.: 18/324,072

(22) Filed: May 25, 2023

(51) Int. Cl. B60W 60/00

(52) U.S. Cl. CPC B60W 60/00253; B60W 60/00256; B60W 2556/40

(57) ABSTRACT

Systems and methods for vehicles to detect and react to scene changes during stops for passenger pick-up, passenger drop-off, and deliveries. In particular, systems and methods are provided for a vehicle to detect a scene change while stopped and move a short distance from its stopped location. In general, after a vehicle has stopped to pick up or drop off a passenger or delivery, the vehicle remains stopped until it begins its drive to a next location.

### BACKGROUND

### 1. Technical Field

The present disclosure generally relates to vehicle perception systems and, more specifically, vehicle perception of scene changes during pick-up and drop-off.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an autonomous vehicle having a change reaction module, according to some examples of the present disclosure;

FIG. 2 illustrates a method for scene change identification and reaction, according to some examples of the present disclosure;

FIGS. 3A and 3B illustrate examples of scene changes, according to some examples of the present disclosure;

FIG. 4 shows an example of an interface for a ridehail service, according to some examples of the present disclosure;

FIG. 5 is a diagram illustrating a fleet of autonomous vehicles in communication with a central computer, according to some embodiments of the disclosure;

FIG. 6 illustrates an example system environment that can be used to facilitate autonomous vehicle (AV) dispatch and operations, according to some aspects of the disclosed technology;

FIG. 7 shows an example embodiment of a system for implementing certain aspects of the present technology; and

FIG. 8 illustrates an example of a deep learning neural network that can be used to implement a perception module and/or one or more validation modules, according to some aspects of the disclosed technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

### Overview

Systems and methods are provided for vehicles to detect and react to scene changes during stops for passenger pick-up, passenger drop-off, and deliveries. In particular, systems and methods are provided for a vehicle to detect a scene change while stopped and move a short distance from its stopped location. In general, after a vehicle has stopped to pick up or drop off a passenger or delivery, the vehicle remains stopped until it begins its drive to a next location.

Autonomous vehicles can be used for ridehail services, delivery services, and other types of services. Traditionally, once an autonomous vehicle has stopped at a waypoint for pick-up or drop-off, it can only depart from the waypoint location after the current trip has ended and when the next trip has started. Once the autonomous vehicle has received another waypoint from dispatch, it can begin driving again. However, while the vehicle is stopped at the waypoint, the vehicle environment can change such that the vehicle may need to move a short distance from its exact stopping location. For example, the autonomous vehicle may be blocking the driveway of an exiting vehicle, and may need to move out of the driveway and/or a few feet along the road to allow the exiting vehicle to pass. In another example, the autonomous vehicle can be blocking a newly arrived emergency vehicle and may need to move down the street or around the corner to give way to the emergency vehicle.

Systems and techniques are provided for enabling live autonomous vehicle perception of scene changes and reaction to scene changes during user pick-up, drop-off, and other vehicle access. In various examples, before moving, the autonomous vehicle first determines that various parameters are met, such as determining that any current passengers are still secured within the vehicle and/or determining that current or previous users are a selected distance away from the vehicle. When an autonomous vehicle detects a scene change and determines a reaction to the scene change is needed, the ride request, delivery request, or other vehicle access request including a pick-up/drop-off/vehicle access location can be updated by a ridehail service to reflect the new vehicle stop location.

Vehicle sensors can be used to capture local scenes and scene changes. In particular, during vehicle perception of the environment during pick-ups, drop-offs, and other vehicle access stops, the sensor suite (including LIDAR, RADAR, and cameras) can perceive the scene around the vehicle and detect changes to the scene. Live autonomous vehicle identification of scene changes and the determination of whether to react to a scene change and how to react to a scene change can be implemented using machine learning. The scene change information can be categorized and labeled such that the autonomous vehicle recognizes features that indicate various types of scene changes. In some examples, based on the live sensor-perceived information and/or sensor-perceived information plus mapped information, autonomous vehicle software can identify a

Example Vehicle for Scene Change Reaction

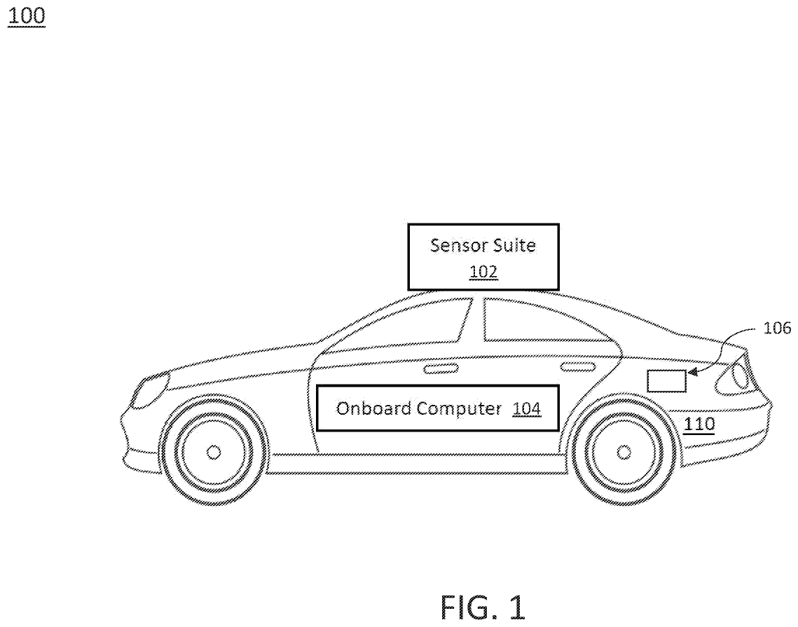

FIG. 1 illustrates an autonomous vehicle 110 having a scene change reaction module 106 that perceives and identifies scene changes during pick-up and drop-off stops, according to some examples of the present disclosure. The autonomous vehicle 110 includes a sensor suite 102 and an onboard computer 104. In various implementations, the autonomous vehicle 110 uses sensor information from the sensor suite 102 to determine its location, to navigate traffic, to sense and avoid obstacles, and to sense its surroundings. According to various implementations, the autonomous vehicle 110 is part of a fleet of vehicles for picking up passengers and/or packages and driving to selected destinations. In some examples, the autonomous vehicle 110 is a personal autonomous vehicle that is used by one or more owners for driving to selected destinations. In some examples, the autonomous vehicle 110 can connect with a central computer to download vehicle updates, maps, and other vehicle data. The scene change reaction module 106 uses vehicle sensor data, such as data from the sensor suite 102, as well as other imaging and/or sensor data, to perceive vehicle surroundings and environmental features during stops, and determine whether to react to the scene change, as described herein.

The sensor suite 102 includes localization and driving sensors. For example, the sensor suite 102 may include one or more of photodetectors, cameras, RADAR, sound navigation and ranging (SONAR), LIDAR, Global Positioning System (GPS), inertial measurement units (IMUs), accelerometers, microphones, strain gauges, pressure monitors, barometers, thermometers, altimeters, wheel speed sensors, and a computer vision system. The sensor suite 102 continuously monitors the autonomous vehicle's environment. In particular, the sensor suite 102 can be used to identify information and determine various factors regarding an autonomous vehicle's environment. In some examples, data from the sensor suite 102 can be used to update a map with information used to develop layers with waypoints identifying various detected items. Additionally, sensor suite 102 data can provide localized traffic information, ongoing road work information, and current road condition information. Furthermore, sensor suite 102 data can provide current environmental information, such as the presence of people, crowds, and/or objects on a roadside or sidewalk. In this way, sensor suite 102 data from many autonomous vehicles can continually provide feedback to the mapping system and a high fidelity map can be updated as more and more information is gathered. The scene change reaction module 106 uses the sensor suite 102 data during vehicle stops for passenger pick-up, passenger drop-off, and delivery stops to continuously evaluate the vehicle stop location and determine whether the vehicle environment has changed such that the vehicle stop location is no longer satisfactory and if the vehicle should drive to a different stop location for the remainder of the stopping time.

In various examples, the sensor suite 102 includes cameras implemented using high-resolution imagers with fixed mounting and field of view. In further examples, the sensor suite 102 includes LIDARs implemented using scanning LIDARs. Scanning LIDARs have a dynamically configurable field of view that provides a point cloud of the region intended to scan. In still further examples, the sensor suite 102 includes RADARs implemented using scanning RADARs with dynamically configurable field of view.

The autonomous vehicle 110 includes an onboard computer 104, which functions to control the autonomous vehicle 110. The onboard computer 104 processes sensed data from the sensor suite 102 and/or other sensors, in order to determine a state of the autonomous vehicle 110. Additionally, the onboard computer 104 processes data for the shelter perception module 106, and can use sensor suite 102 data for identifying various roadside shelters. In some examples, the onboard computer 104 checks for vehicle updates from a central computer or other secure access point. In some examples, a vehicle sensor log receives and stores processed sensed sensor suite 102 data from the onboard computer 104. In some examples, a vehicle sensor log receives sensor suite 102 data from the sensor suite 102. In some implementations described herein, the autonomous vehicle 110 includes sensors inside the vehicle. In some examples, the autonomous vehicle 110 includes one or more cameras inside the vehicle. The cameras can be used to detect items or people inside the vehicle. In some examples, the autonomous vehicle 110 includes one or more weight sensors inside the vehicle, which can be used to detect items or people inside the vehicle. In some examples, the interior sensors can be used to detect passengers inside the vehicle. Additionally, based upon the vehicle state and programmed instructions, the onboard computer 104 controls and/or modifies driving behavior of the autonomous vehicle 110. In some examples, the scene change reaction module 106 evaluates interior sensor data to determine whether there are passengers inside the vehicle, and, if there are passengers inside the vehicle, whether the passengers are secured and the vehicle can drive to a different stopping location.

The onboard computer 104 functions to control the operations and functionality of the autonomous vehicle 110 and processes sensed data from the sensor suite 102 and/or other sensors in order to determine states of the autonomous vehicle. In some implementations, the onboard computer 104 is a general purpose computer adapted for I/O communication with vehicle control systems and sensor systems. In some implementations, the onboard computer 104 is any suitable computing device. In some implementations, the onboard computer 104 is connected to the Internet via a wireless connection (e.g., via a cellular data connection). In some examples, the onboard computer 104 is coupled to any number of wireless or wired communication systems. In some examples, the onboard computer 104 is coupled to one or more communication systems via a mesh network of devices, such as a mesh network formed by autonomous vehicles.

According to various implementations, the autonomous driving system 100 of FIG. 1 functions to enable an autonomous vehicle 110 to modify and/or set a driving behavior in response to parameters set by vehicle passengers (e.g., via a passenger interface). Driving behavior of an autonomous vehicle may be modified according to explicit input or feedback (e.g., a passenger specifying a maximum speed or a relative comfort level), implicit input or feedback (e.g., a passenger's heart rate), or any other suitable data or manner of communicating driving behavior preferences.

The autonomous vehicle 110 is preferably a fully autonomous automobile, but may additionally or alternatively be any semi-autonomous or fully autonomous vehicle. In various examples, the autonomous vehicle 110 is a boat, an unmanned aerial vehicle, a driverless car, a golf cart, a truck, a van, a recreational vehicle, a train, a tram, a three-wheeled vehicle, a bicycle, a scooter, a tractor, a lawn mower, a commercial vehicle, an airport vehicle, or a utility vehicle. Additionally, or alternatively, the autonomous vehicles may be vehicles that switch between a semi-autonomous state and a fully autonomous state and thus, some autonomous vehicles may have attributes of both a semi-autonomous vehicle and a fully autonomous vehicle depending on the state of the vehicle.

In various implementations, the autonomous vehicle 110 includes a throttle interface that controls an engine throttle, motor speed (e.g., rotational speed of electric motor), or any other movement-enabling mechanism. In various implementations, the autonomous vehicle 110 includes a brake interface that controls brakes of the autonomous vehicle 110 and controls any other movement-retarding mechanism of the autonomous vehicle 110. In various implementations, the autonomous vehicle 110 includes a steering interface that controls steering of the autonomous vehicle 110. In one example, the steering interface changes the angle of wheels of the autonomous vehicle. The autonomous vehicle 110 may additionally or alternatively include interfaces for control of any other vehicle functions, for example, windshield wipers, headlights, turn indicators, air conditioning, etc.

### Example Method for Perception of and Reaction to Scene Changes

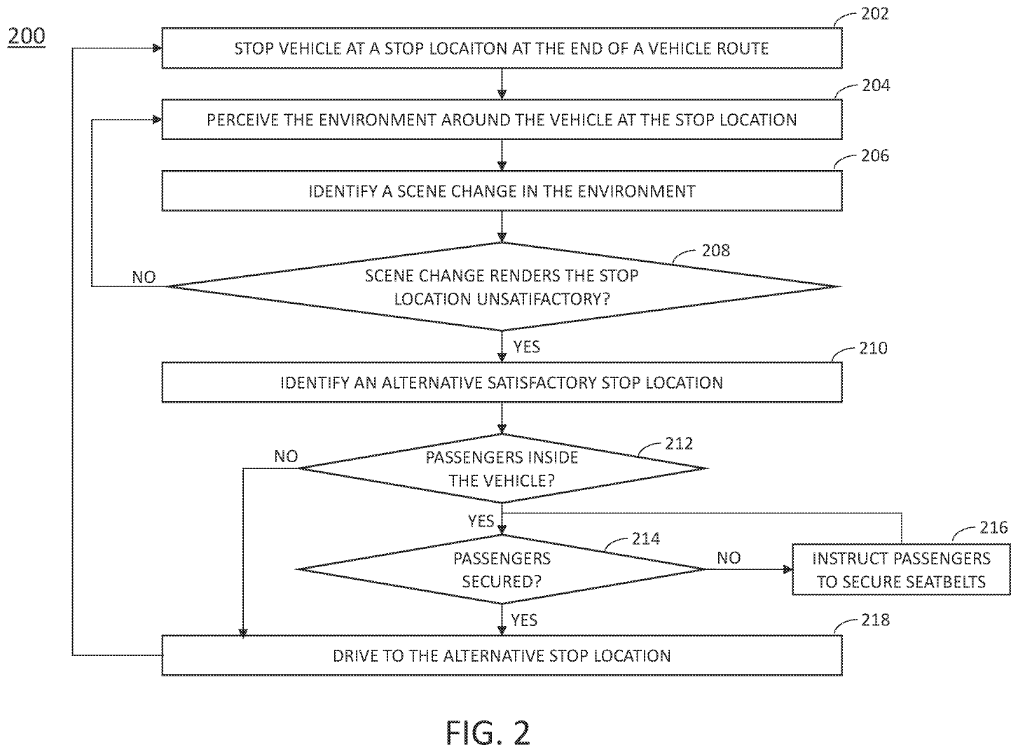

FIG. 2 is a flow chart illustrating an example of a method 200 for vehicle perception of and reaction to scene changes, according to some examples of the present disclosure. At step 202, the vehicle stops at a stop location at the end of a vehicle route. In particular, in various examples, the vehicle follows a first route to the stop location, where the vehicle stops until it receives another waypoint from a dispatch service and begins a second route to a next location. In some examples, while the vehicle is stopped at the stop location, one or more passengers can be dropped off, and/or one or more passengers can be picked up. Additionally, in some examples, while the vehicle is stopped at the stop location, a delivery can be picked up from the vehicle by a user and/or a delivery can be dropped off to the vehicle by a user.

At step 204, while the vehicle is stopped at the stop location, the vehicle perceives its surrounding environment. In particular, vehicle sensors detect the environment around the vehicle, and a scene change reaction module identifies changes in the environment. In various examples, the vehicle sensors include imaging sensors, cameras, LIDAR sensors, and RADAR sensors. The scene change reaction module uses vehicle sensor data to identify changes in the environment. In various examples, the scene change reaction module can detect any type of environmental change, such as a person, animal, or vehicle entering, moving within, and/or leaving the vehicle's surrounding environment.

At step 206, the scene change reaction module identifies a scene change in environment. In particular, the scene change reaction module detects environmental changes and identifies the selected environmental changes that qualify as scene changes. Many environmental changes can occur that do not substantively change the scene for the stopped vehicle. For example, another vehicle driving by the stopped vehicle is a temporary environmental change that does not substantively change the scene for the stopped vehicle. Similarly, a pedestrian walking by the stopped vehicle is a temporary environmental change that does not substantively change the scene for the stopped vehicle. In another example, a squirrel running across a driveway or road in front of the stopped vehicle is a temporary environmental change that does not substantively change the scene for the stopped vehicle. In some examples, a scene change is a non-temporary environmental change. In one example, a scene change can be an environmental change that remains static for a selected period of time. The selected period of time can be a few seconds, such as for two seconds, three seconds, five seconds, or for more than five seconds. For example, if a vehicle parks behind the stopped vehicle, this can qualify as a scene change.

At step 208, the scene change reaction module determines whether the scene change renders the stop location unsatisfactory. If the scene change simply involves another car parking nearby, or a pedestrian stopping for a few minutes while their dog explores a nearby bush, the scene change does not render the stop location unsatisfactory, as no substantial change has occurred that affects the stopped vehicle or the suitability of the stopping location. If the scene change does not render the stop location unsatisfactory, the method 200 returns to step 204 and the scene change reaction module continues to monitor the surrounding environment.

Some scene changes can directly affect the suitability of the stop location and render the stop location unsatisfactory. In some examples, an unsatisfactory stop location can be a stop location that an emergency vehicle indicates a need for access to. In some examples, when an emergency vehicle stops within a selected distance of the stopped vehicle, the stop location becomes unsatisfactory, as vehicles are to stop a selected distance away from active emergency vehicles under a local regulation. In some examples, an emergency vehicle can pull up behind or next to the stopped vehicle and request the stopped vehicle move. For instance, the emergency vehicle can sound a siren, flash lights, honk a horn, or otherwise request the stopped vehicle move. For example, a fire truck can pull up behind or beside the stopped vehicle and indicate for the stopped vehicle to move. Similarly, an ambulance can pull up behind or beside the stopped vehicle and indicate for the stopped vehicle to move. In other examples, a police car can pull up behind or beside the stopped vehicle and indicate for the stopped vehicle to move. In some examples, an unsatisfactory stop location can be a stop location that prevents another vehicle from accessing a selected roadway. For instance, in some examples, the stopped vehicle is parked in a driveway, or blocking the end of a driveway, and another vehicle is attempting to exit or enter the driveway. The other vehicle can indicate a request for the stopped vehicle to move, such as by honking a horn. In some examples, an unwanted public interaction (UPI) can occur at or near the vehicle that renders the stop location unsatisfactory. A UPI can include one or more unruly pedestrians and/or an action taken on or against the vehicle (e.g., potential vandalism). In any of these examples, and in other situations, the stop location of the stopped vehicle is no longer satisfactory. When the scene change renders the stop location unsatisfactory, the method 200 proceeds to step 210.

At step 210, an alternative satisfactory stop location is identified. In particular, in some examples, once the scene change reaction module determines that the first stop location is unsatisfactory, the vehicle can identify an alternative stop location that is satisfactory. In some examples, the scene change reaction module transmits a message to the onboard computer to identify an alternative stop location. The onboard computer can use vehicle sensor data to identify an alternative stop location. The onboard computer can refer to a map in a mapping database to identify an alternative stop location. In some examples, when the alternative stop location is identified on a map, the onboard computer uses vehicle sensor data to determine whether the alternative stop location is satisfactory. For example, the onboard computer uses vehicle sensor data to determine that the alternative stop location is available (e.g., no other vehicle is parked there), and the onboard computer uses vehicle sensor data to determine that the alternative stop location is satisfactory (e.g., it does not block another vehicle, and there are no emergency vehicles or other signs indicating that the alternative stop location should be left open). In some examples, the onboard computer requests an alternative stop location from a central computer and/or from dispatch.

In some implementations, once the scene change reaction module determines that the first stop location is unsatisfactory, the scene change reaction module communicates with a central computer to request an alternative stop location. In some implementations, once the scene change reaction module determines that the first stop location is unsatisfactory, the onboard computer communicates with a central computer to request an alternative stop location. A central computer can use mapping data to identify an alternative stop location, and transmit the alternative stop location to the onboard computer (and/or to the scene change reaction module). In some examples, the scene change reaction module uses vehicle sensor data to determine whether the alternative stop location is satisfactory. In some examples, the onboard computer uses vehicle sensor data to determine whether the alternative stop location is satisfactory. For example, the onboard computer uses vehicle sensor data to determine that the alternative stop location is available (e.g., no other vehicle is parked there), and the onboard computer uses vehicle sensor data to determine that the alternative stop location is satisfactory (e.g., it does not block another vehicle, and there are no emergency vehicles or other signs indicating that the alternative stop location should be left open). In some examples, if the alternative stop location is not satisfactory, the onboard computer requests a new alternative stop location from a central computer and/or from dispatch.

In some examples, the stopped vehicle can move a short distance. For instance, if the stopped vehicle is blocking a driveway, the stopped vehicle could move a short distance forward or backward, and allow the other vehicle access to the driveway. In some examples, the stopped vehicle can return to the first stop location after driving to the alternative stop location and waiting for the other vehicle to complete its use of the previously blocked roadway. In some examples, the stopped vehicle identifies an alternative stop location that is further away, such as around a corner, or around a block. For instance, if emergency vehicles request the stopped vehicle move, the emergency vehicles may use a large section of the roadway and the alternative stop location for the stopped vehicle may be further away.

Before the stopped vehicle moves to the alternative stop location, at step 212, it is determined whether there are any passengers inside the vehicle. In some examples, interior vehicle sensor data is used to determine whether there are any passengers inside the vehicle. In some examples, the onboard computer utilizes interior vehicle sensor data to determine whether there are any passengers inside the vehicle. If there are no passengers in the vehicle, the method 200 proceeds to step 218 and the vehicle drives to the alternative stop location. In some examples, a message is transmitted to the ridehail or delivery application informing the user(s) of the new location (i.e., the alternative stop location). The message can also inform the passenger(s) what the scene change is (e.g., an emergency vehicle is detected).

If, at step 212, it is determined that there is one or more passengers in the vehicle, the method 200 proceeds to step 214 and it is determined whether the passengers are secured. If the passengers are secured, the method 200 proceeds to step 218 and the vehicle drives to the alternative stop location. In some examples, before the method 200 proceeds to step 218, and before the vehicle begins its drive to the alternative stop location, a message is provided to the passenger(s) informing the passenger(s) of the scene change and that the vehicle is relocating to the alternative stop location. The message can be an audio message played over one or more speakers in the vehicle cabin. The message can include a visual message displayed on one or more screens in the vehicle cabin. In some examples, the message is transmitted to a passenger ridehail application, and the message is displayed on a passenger mobile device.

If, at step 214, it is determined that the passengers are not secured, the method 200 proceeds to step 216 and the vehicle instructs the passengers to secure their seatbelts. The method 200 then returns to step 214 and determines whether the passengers are secured. Once the passengers are secured, the method 200 proceeds to step 218 and the vehicle drives to the alternative stop location. As described above, before the method 200 proceeds to step 218, and before the vehicle begins its drive to the alternative stop location, a message is provided to the passenger(s) informing the passenger(s) of the scene change and that the vehicle is relocating to the alternative stop location.

In various implementations, the stopped vehicle can also determine whether a user is approaching the vehicle, such as to pick up a delivery. In some examples, if a user is approaching the vehicle at step 212, and is within a selected distance of the stopped vehicle, the vehicle remains stopped until the user has stopped approaching the vehicle. In some examples, the user can stop and wait for the vehicle to move to the alternative location. In some examples, the user can turn around or walk past the vehicle. And, in some examples, the user can access the vehicle to retrieve a delivery, and then walk away from the vehicle.

In some examples, before the vehicle drives to the alternative stop location at step 218, the vehicle transmits a notification of the new stop location to the central computer. The central computer can transmit the new stop location to a ridehail application, and the ridehail application can display the new stop location on a user interface. In various examples, a ridehail user is presented with the new stop location in the ridehail application user interface.

In some implementations, at step 218, the method 200 returns to step 202, and the environment around the alternative stop location is monitored for scene changes.

### Example Diagrams of Perception of and Reaction to Scene Changes

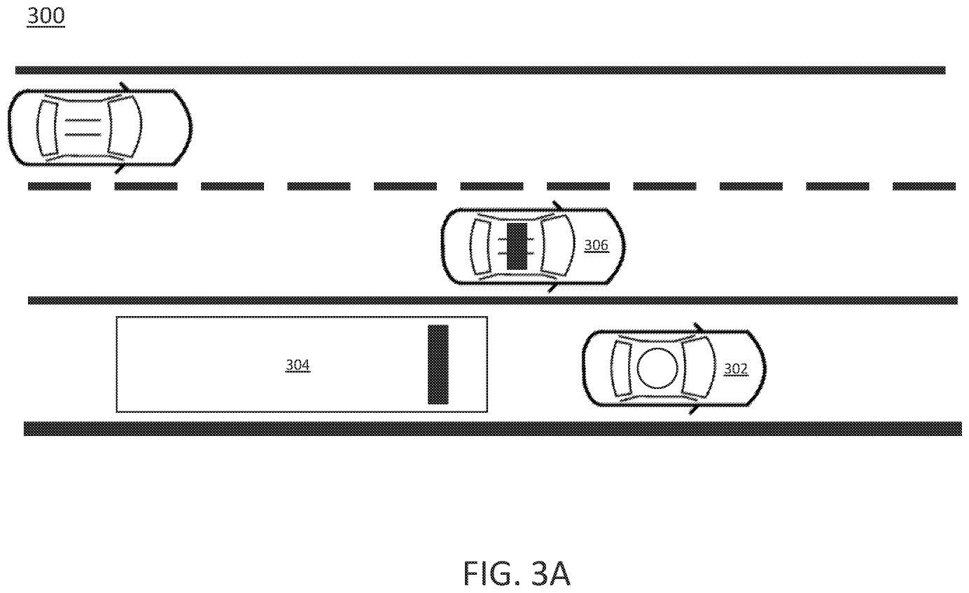

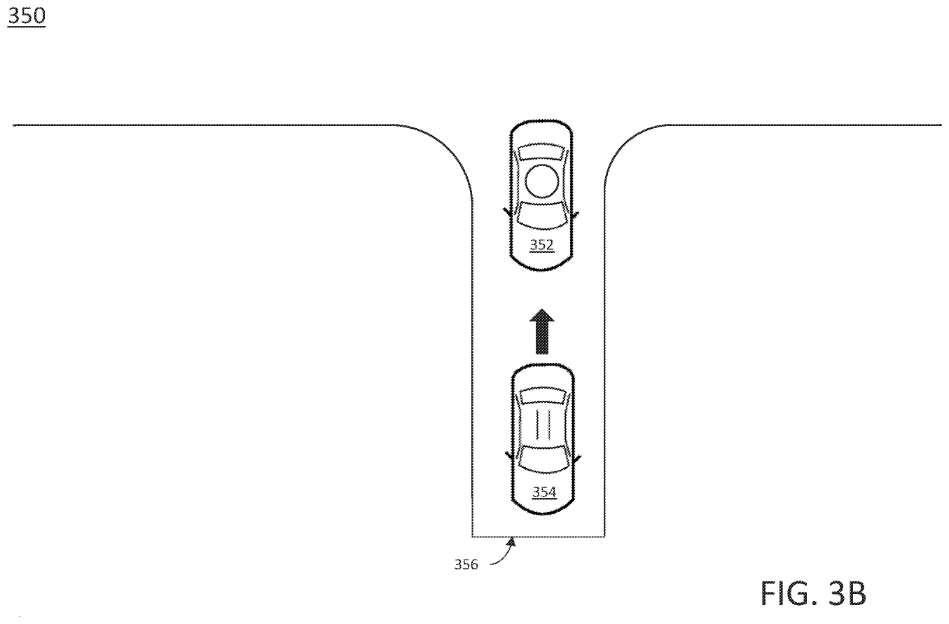

FIGS. 3A and 3B are block diagrams illustrating examples of perception of and reaction to scene changes, according to some examples of the present disclosure. In particular, FIG. 3A is a diagram 300 illustrating a first vehicle 302 stopped at the side of a road. In various examples, the side of the road is the stop location for the first vehicle 302 at the end of a vehicle route. In particular, in various examples, the first vehicle followed a first route to the stop location, and the first vehicle is stopped at the stop location until the first vehicle receives another waypoint from a dispatch service and begins a second route to a next location. In some examples, while the vehicle is stopped at the stop location, one or more passengers can be dropped off, and/or one or more passengers can be picked up. Additionally, in some examples, while the vehicle is stopped at the stop location, a delivery can be picked up from the vehicle by a user and/or a delivery can be dropped off to the vehicle by a user.

As shown in FIG. 3A, two emergency vehicles are present on the road, according to some examples of the present disclosure. A first emergency vehicle is a firetruck 304, and a second emergency vehicle is a police car 306. In various examples, one or both of the firetruck 304 and the police car 306 request that the first vehicle 302 move from the stop location at the side of the road. In some examples, one or both of the firetruck 304 and the police car 306 sound sirens indicating that the first vehicle 302 is to move from the stop location. In some examples, one or both of the firetruck 304 and the police car 306 flash emergency lights indicating that the first vehicle 302 is to move from the stop location. In some examples, one or both of the firetruck 304 and the police car 306 honk their horns, and/or sound a verbal request over a speaker requesting that the first vehicle 302 move.

The first vehicle 302 includes a scene change reaction module that identifies the scene change when the fire truck 304 arrives, and identifies the scene changes when the police car 306 arrives. In some examples, the scene change reaction module receives the one or more indications from the fire truck 304 and/or the police car 306 that the stop location is no longer satisfactory. In some examples, the scene change reaction module receives the one or more requests from the fire truck 304 and/or the police car 306 to move from the stop location. The first vehicle 302 can perform the method 200 described above with respect to FIG. 2 and move from the stop location to an alternative location.

FIG. 3B is a diagram 350 illustrating a first autonomous vehicle 352 and a second vehicle 354, according to some examples of the present disclosure. As shown in FIG. 3B, the second vehicle 354 is reversing and attempting to exit the driveway 356. The first autonomous vehicle 352 is stopped behind the second vehicle 354, blocking the second vehicle 354, and preventing the second vehicle 354 from exiting the driveway 356. In various examples, the second vehicle 354 requests that the first autonomous vehicle 352 move from the stop location blocking the driveway and preventing the second vehicle 354 from exiting. In some examples, the vehicle 354 switches into reverse and its reverse lights illuminate, indicating that it is attempting to move and that the first autonomous vehicle 352 is blocking the second vehicle 354 from exiting. In some examples, the vehicle 354 honks its horns, and/or makes a verbal request that the first autonomous vehicle 352 move.

The first autonomous vehicle 352 includes a scene change reaction module that identifies the scene change when the reverse lights on the second vehicle 354 illuminate, and/or identifies the scene changes when the second vehicle 354 honks its horn. In some examples, the scene change reaction module receives the one or more indications from the second vehicle 354 that the stop location is no longer satisfactory. In some examples, the scene change reaction module receives the one or more requests from the second vehicle 354 to move from the stop location. The first autonomous vehicle 352 can perform the method 200 described above with respect to FIG. 2 and move from the stop location to an alternative location.

### Example Interface for Scene Change Reaction

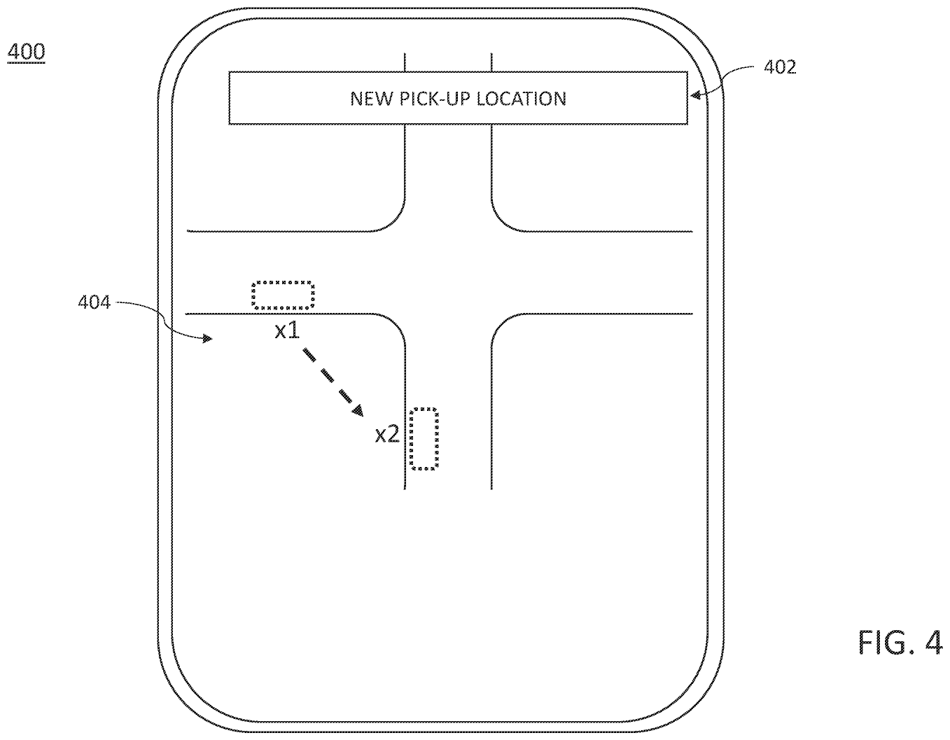

FIG. 4 shows an example 400 of an interface for a ridehail service, according to some examples of the present disclosure. In particular, FIG. 4 shows an alert 402 that can be displayed when a user is waiting for a vehicle for pick-up and/or when a user is a passenger in the vehicle and awaiting drop-off. The prompt 402 alerts the user that the vehicle stop location has changed and the vehicle is moving from the stop location x1 to a new stop location x2. The interface displays a map including the first stop location x1 and the new stop location x2, as well as an arrow indicating the change in the location of user access to the vehicle.

### Example of an Autonomous Vehicle Fleet

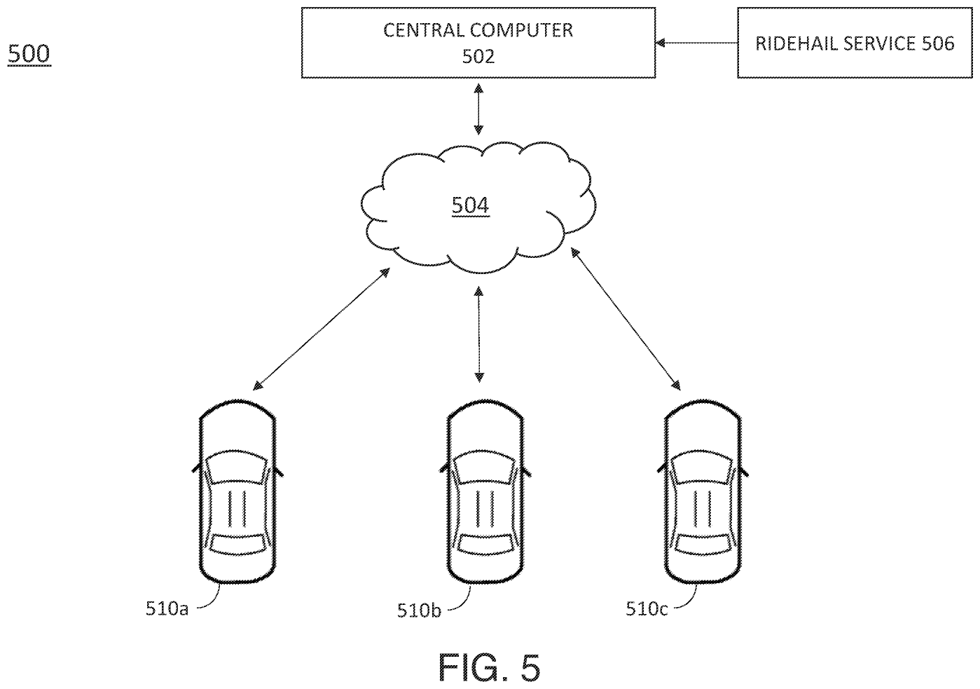

FIG. 5 is a diagram 500 illustrating a fleet of autonomous vehicles 510a, 510b, 510c in communication with a central computer 502, according to some embodiments of the disclosure. The vehicles 510a-510c communicate wirelessly with a cloud 504 and a central computer 502. The central computer 502 includes a routing coordinator and a database of information from the vehicles 510a-510c in the fleet. The database of information can include the stop location of any vehicle currently stopped at the end of a route as discussed herein. The database of information can also include planned stop locations for vehicles currently en route. The central computer 502 can also include a map database, and the central computer 502 can access the map database to identify a stop location for any of the vehicles 510a-510c. Autonomous vehicle fleet routing refers to the routing of multiple vehicles in a fleet. The central computer also acts as a centralized ride management system and communicates with ridehail users via a ridehail service 506. In various examples, the ridehail service 506 includes a rideshare service (and rideshare users) as well as an autonomous vehicle delivery service. Via the ridehail service 506, the central computer receives ride requests from various user ridehail applications. In some implementations, the ride requests include a pick-up location, a drop-off location, and/or a an intermediate stopping location. In some implementations, a delivery request includes vehicle access locations for delivery pick-up and for delivery drop-off. In some implementations, the autonomous vehicles 510a-510c communicate directly with each other. Each received ride request and delivery request can be assigned, by the central computer 502, to a vehicle in the fleet.

When a ride request is entered at a ridehail service 506, the ridehail service 506 sends the request to the central computer 502. In some examples, during a selected period of time before the ride begins, the vehicle to fulfill the request is selected and a route for the vehicle is generated by the routing coordinator. In other examples, the vehicle to fulfill the request is selected and the route for the vehicle is generated by the onboard computer on the autonomous vehicle. The route can be based on the vehicle's current stop location and/or based on a planned stop location for the vehicle at the end of a current route. In various examples, information pertaining to the ride is transmitted to the selected vehicle 510a-510c. With shared rides, the route for the vehicle can depend on other passenger pick-up and drop-off locations. Each of the autonomous vehicles 510a, 510b, 510c in the fleet includes a scene change reaction module for detecting scene changes when a vehicle is stopped at the end of a route as described herein. The vehicles 510a, 510b, 510c communicate with the central computer 502 via the cloud 504. In some examples, when a vehicle 510a, 510b, 510c moves from a stop location to an alternative stop location, as described herein, the vehicle 510a, 510b, 510c communicates the move and the alternative stop location with the central computer 502. In some examples, when the scene change reaction module of a vehicle 510a-510c determines that a stop location is unsatisfactory, the vehicle 510a-510c communicates with the central computer 502 to request an alternative stop location.

As described above, each vehicle 510a-510c in the fleet of vehicles communicates with a routing coordinator. Thus, information gathered by various autonomous vehicles 510a-510c in the fleet can be saved and used to generate information for future routing determinations. For example, sensor data can be used to generate route determination parameters. In general, the information collected from the vehicles in the fleet can be used for route generation or to modify existing routes. For example, information regarding emergency vehicles stopped in a selected area and requesting a vehicle move from a stop location in the area can be communicated to the routing coordinator and used to generate routes and modify existing routes to avoid the selected area for a selected period of time. In some examples, the routing coordinator collects and processes position data from multiple autonomous vehicles in real-time to avoid traffic and generate a fastest-time route for each autonomous vehicle. In some implementations, the routing coordinator uses collected position data to generate a best route for an autonomous vehicle in view of one or more traveling preferences and/or routing goals. In some examples, the routing coordinator uses collected position data corresponding to emergency events to generate a best route for an autonomous vehicle to avoid a potential emergency situation and associated unknowns.

According to various implementations, a set of parameters can be established that determine which metrics are considered (and to what extent) in determining routes or route modifications. For example, expected congestion or traffic based on a known event can be considered. Generally, a routing goal refers to, but is not limited to, one or more desired attributes of a routing plan indicated by at least one of an administrator of a routing server and a user of the autonomous vehicle. The desired attributes may relate to a desired duration of a route plan, a comfort level of the route plan, a vehicle type for a route plan, safety of the route plan, and the like. For example, a routing goal may include time of an individual trip for an individual autonomous vehicle to be minimized, subject to other constraints. As another example, a routing goal may be that comfort of an individual trip for an autonomous vehicle be enhanced or maximized, subject to other constraints. Routing goals can also be considered in suggesting sheltered stop locations. For instance, it may be beneficial for routing purposes to stop around the corner from an input location, and a roadside shelter may also be present at the more beneficial location.

Routing goals may be specific or general in terms of both the vehicles they are applied to and over what timeframe they are applied. As an example of routing goal specificity in vehicles, a routing goal may apply only to a specific vehicle, or to all vehicles in a specific region, or to all vehicles of a specific type, etc. Routing goal timeframe may affect both when the goal is applied (e.g., some goals may be ‘active’ only during set times) and how the goal is evaluated (e.g., for a longer-term goal, it may be acceptable to make some decisions that do not optimize for the goal in the short term, but may aid the goal in the long term). Likewise, routing vehicle specificity may also affect how the goal is evaluated; e.g., decisions not optimizing for a goal may be acceptable for some vehicles if the decisions aid optimization of the goal across an entire fleet of vehicles.

Some examples of routing goals include goals involving trip duration (either per trip, or average trip duration across some set of vehicles and/or times), physics, and/or company policies (e.g., adjusting routes chosen by users that end in lakes or the middle of intersections, refusing to take routes on highways, etc.), distance, velocity (e.g., max., min., average), source/destination (e.g., it may be optimal for vehicles to start/end up in a certain place such as in a pre-approved parking space or charging station), intended arrival time (e.g., when a user wants to arrive at a destination), duty cycle (e.g., how often a car is on an active trip vs. idle), energy consumption (e.g., gasoline or electrical energy), maintenance cost (e.g., estimated wear and tear), money earned (e.g., for vehicles used for ridehailing), person-distance (e.g., the number of people moved multiplied by the distance moved), occupancy percentage, higher confidence of arrival time, user-defined routes or waypoints, fuel status (e.g., how charged a battery is, how much gas is in the tank), passenger satisfaction (e.g., meeting goals set by or set for a passenger) or comfort goals, environmental impact, toll cost, etc. In examples where vehicle demand is important, routing goals may include attempting to address or meet vehicle demand.

Routing goals may be combined in any manner to form composite routing goals; for example, a composite routing goal may attempt to optimize a performance metric that takes as input trip duration, ridehail revenue, and energy usage and also, optimize a comfort metric. The components or inputs of a composite routing goal may be weighted differently and based on one or more routing coordinator directives and/or passenger preferences.

Likewise, routing goals may be prioritized or weighted in any manner. For example, a set of routing goals may be prioritized in one environment, while another set may be prioritized in a second environment. As a second example, a set of routing goals may be prioritized until the set reaches threshold values, after which point a second set of routing goals takes priority. Routing goals and routing goal priorities may be set by any suitable source (e.g., an autonomous vehicle routing platform, an autonomous vehicle passenger).

The routing coordinator uses maps to select an autonomous vehicle from the fleet to fulfill a ride request. In some implementations, the routing coordinator sends the selected autonomous vehicle the ride request details, including pick-up location and destination location, and an onboard computer on the selected autonomous vehicle generates a route and navigates to the destination. In some implementations, the routing coordinator in the central computer 502 generates a route for each selected autonomous vehicle 510a-510c, and the routing coordinator determines a route for the autonomous vehicle 510a-510c to travel from the autonomous vehicle's current location to a first destination.

### Example Autonomous Vehicle Management System

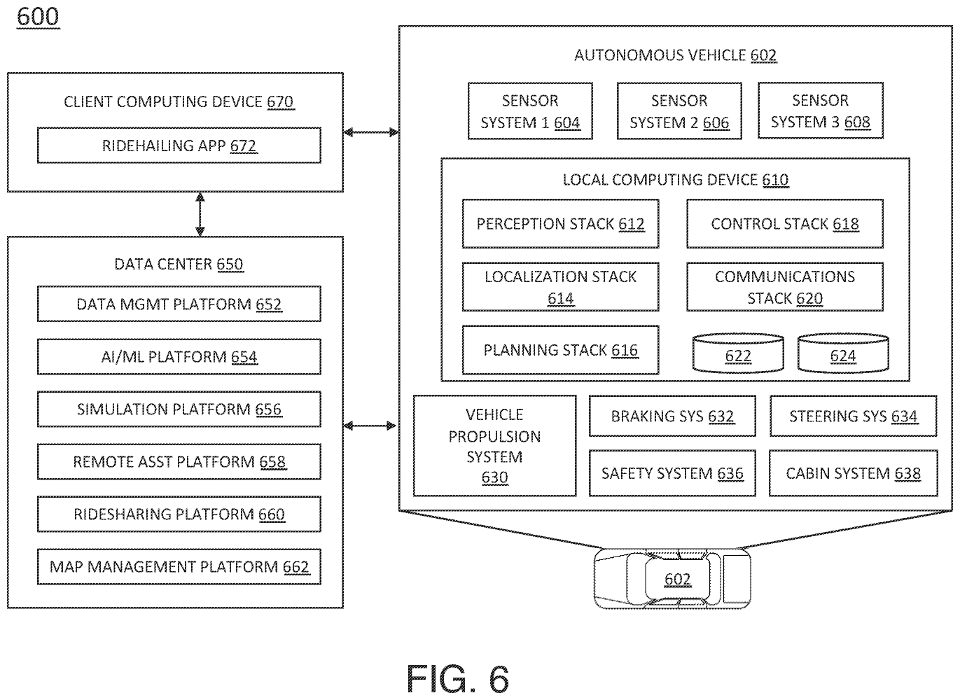

Turning now to FIG. 6, this figure illustrates an example of an AV management system 600. One of ordinary skill in the art will understand that, for the AV management system 600 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 600 includes an AV 602, a data center 650, and a client computing device 670. The AV 602, the data center 650, and the client computing device 670 can communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 602 can navigate about roadways without a human driver based on sensor signals generated by multiple sensor systems 604, 606, and 608. The sensor systems 604-608 can include different types of sensors and can be arranged about the AV 602. For instance, the sensor systems 604-608 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 604 can be a camera system, the sensor system 606 can be a LIDAR system, and the sensor system 608 can be a RADAR system. Other embodiments may include any other number and type of sensors. In various examples, the sensor systems can be used to provide surveillance of the environment surrounding the vehicle. In some examples, the vehicle scene change reaction module can use vehicle sensor data to observe the surrounding environment and identify scene changes when a vehicle is stopped.

AV 602 can also include several mechanical systems that can be used to maneuver or operate AV 602. For instance, the mechanical systems can include vehicle propulsion system 630, braking system 632, steering system 634, safety system 636, and cabin system 638, among other systems. Vehicle propulsion system 630 can include an electric motor, an internal combustion engine, or both. The braking system 632 can include an engine brake, a wheel braking system (e.g., a disc braking system that utilizes brake pads), hydraulics, actuators, and/or any other suitable componentry configured to assist in decelerating AV 602. The steering system 634 can include suitable componentry configured to control the direction of movement of the AV 602 during navigation. Safety system 636 can include lights and signal indicators, a parking brake, airbags, and so forth. The cabin system 638 can include cabin temperature control systems, in-cabin entertainment systems, and so forth. In some embodiments, the AV 602 may not include human driver actuators (e.g., steering wheel, handbrake, foot brake pedal, foot accelerator pedal, turn signal lever, window wipers, etc.) for controlling the AV 602. Instead, the cabin system 638 can include one or more client interfaces (e.g., Graphical User Interfaces (GUIs), Voice User Interfaces (VUIs), etc.) for controlling certain aspects of the mechanical systems 630-638.

AV 602 can additionally include a local computing device 610 that is in communication with the sensor systems 604-608, the mechanical systems 630-638, the data center 650, and the client computing device 670, among other systems. The local computing device 610 can include one or more processors and memory, including instructions that can be executed by the one or more processors. The instructions can make up one or more software stacks or components responsible for controlling the AV 602; communicating with the data center 650, the client computing device 670, and other systems; receiving inputs from riders, passengers, and other entities within the AV's environment; logging metrics collected by the sensor systems 604-608; and so forth. In this example, the local computing device 610 includes a perception stack 612, a mapping and localization stack 614, a planning stack 616, a control stack 618, a communications stack 620, a High Definition (HD) geospatial database 622, and an AV operational database 624, among other stacks and systems.

Perception stack 612 can enable the AV 602 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 604-608, the mapping and localization stack 614, the HD geospatial database 622, other components of the AV, and other data sources (e.g., the data center 650, the client computing device 670, third-party data sources, etc.). The perception stack 612 can detect and classify objects and determine their current and predicted locations, speeds, directions, and the like. In addition, the perception stack 612 can determine the free space around the AV 602 (e.g., to maintain a safe distance from other objects, change lanes, park the AV, etc.). The perception stack 612 can also identify environmental uncertainties, such as where to look for moving objects, flag areas that may be obscured or blocked from view, and so forth. The perception stack 612 can be used by the scene change reaction module to sense the vehicle environment and identify scene changes.

Mapping and localization stack 614 can determine the AV's position and orientation (pose) using different methods from multiple systems (e.g., GPS, IMUs, cameras, LIDAR, RADAR, ultrasonic sensors, the HD geospatial database 622, etc.). For example, in some embodiments, the AV 602 can compare sensor data captured in real-time by the sensor systems 604-608 to data in the HD geospatial database 622 to determine its precise (e.g., accurate to the order of a few centimeters or less) position and orientation. The AV 602 can focus its search based on sensor data from one or more first sensor systems (e.g., GPS) by matching sensor data from one or more second sensor systems (e.g., LIDAR). If the mapping and localization information from one system is unavailable, the AV 602 can use mapping and localization information from a redundant system and/or from remote data sources.

The planning stack 616 can determine how to maneuver or operate the AV 602 safely and efficiently in its environment. For example, the planning stack 616 can receive the location, speed, and direction of the AV 602, geospatial data, data regarding objects sharing the road with the AV 602 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 602 from one point to another. The planning stack 616 can determine multiple sets of one or more mechanical operations that the AV 602 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right;

decelerate until completely stopped and reverse; etc.), and select the best one to meet changing road conditions and events. If something unexpected happens, the planning stack 616 can select from multiple backup plans to carry out. For example, while preparing to change lanes to turn right at an intersection, another vehicle may aggressively cut into the destination lane, making the lane change unsafe. The planning stack 616 could have already determined an alternative plan for such an event, and upon its occurrence, help to direct the AV 602 to go around the block instead of blocking a current lane while waiting for an opening to change lanes.

The control stack 618 can manage the operation of the vehicle propulsion system 630, the braking system 632, the steering system 634, the safety system 636, and the cabin system 638. The control stack 618 can receive sensor signals from the sensor systems 604-608 as well as communicate with other stacks or components of the local computing device 610 or a remote system (e.g., the data center 650) to effectuate operation of the AV 602. For example, the control stack 618 can implement the final path or actions from the multiple paths or actions provided by the planning stack 616. This can involve turning the routes and decisions from the planning stack 616 into commands for the actuators that control the AV's steering, throttle, brake, and drive unit.

The communication stack 620 can transmit and receive signals between the various stacks and other components of the AV 602 and between the AV 602, the data center 650, the client computing device 670, and other remote systems. The communication stack 620 can enable the local computing device 610 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 620 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 622 can store HD maps and related data of the streets upon which the AV 602 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

The AV operational database 624 can store raw AV data generated by the sensor systems 604-608 and other components of the AV 602 and/or data received by the AV 602 from remote systems (e.g., the data center 650, the client computing device 670, etc.). In some embodiments, the raw AV data can include HD LIDAR point cloud data, image or video data, RADAR data, GPS data, and other sensor data that the data center 650 can use for creating or updating AV geospatial data as discussed further below with respect to FIG. 5 and elsewhere in the present disclosure.

The data center 650 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 650 can include one or more computing devices remote to the local computing device 610 for managing a fleet of AVs and AV-related services. For example, in addition to managing the AV 602, the data center 650 may also support a ridesharing service, a delivery service, a remote/roadside assistance service, street services (e.g., street mapping, street patrol, street cleaning, street metering, parking reservation, etc.), and the like.

The data center 650 can send and receive various signals to and from the AV 602 and the client computing device 670. These signals can include sensor data captured by the sensor systems 604-608, roadside assistance requests, software updates, ridesharing pick-up and drop-off instructions, and so forth. In this example, the data center 650 includes one or more of a data management platform 652, an Artificial Intelligence/Machine Learning (Al/ML) platform 654, a simulation platform 656, a remote assistance platform 658, a ridesharing platform 660, and a map management platform 662, among other systems.

Data management platform 652 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 650 can access data stored by the data management platform 652 to provide their respective services.

The AI/ML platform 654 can provide the infrastructure for training and evaluating machine learning algorithms for operating the AV 602, the simulation platform 656, the remote assistance platform 658, the ridesharing platform 660, the map management platform 662, and other platforms and systems. Using the AI/ML platform 654, data scientists can prepare data sets from the data management platform 652; select, design, and train machine learning models; evaluate, refine, and deploy the models; maintain, monitor, and retrain the models; and so on.

The simulation platform 656 can enable testing and validation of the algorithms, machine learning models, neural networks, and other development efforts for the AV 602, the remote assistance platform 658, the ridesharing platform 660, the map management platform 662, and other platforms and systems. The simulation platform 656 can replicate a variety of driving environments and/or reproduce real-world scenarios from data captured by the AV 602, including rendering geospatial information and road infrastructure (e.g., streets, lanes, crosswalks, traffic lights, stop signs, etc.) obtained from the map management platform 662; modeling the behavior of other vehicles, bicycles, pedestrians, and other dynamic elements; simulating inclement weather conditions, different traffic scenarios; and so on.

The remote assistance platform 658 can generate and transmit instructions regarding the operation of the AV 602. For example, in response to an output of the Al/ML platform 654 or other system of the data center 650, the remote assistance platform 658 can prepare instructions for one or more stacks or other components of the AV 602.

The ridesharing platform 660 can interact with a customer of a ridesharing service via a ridesharing application 672 executing on the client computing device 670. The client computing device 670 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 672. The client computing device 670 can be a customer's mobile computing device or a computing device integrated with the AV 602 (e.g., the local computing device 610). The ridesharing platform 660 can receive requests to be picked up or dropped off from the ridesharing application 672 and dispatch the AV 602 for the trip.

Map management platform 662 can provide a set of tools for the manipulation and management of geographic and spatial (geospatial) and related attribute data. The data management platform 652 can receive LIDAR point cloud data, image data (e.g., still image, video, etc.), RADAR data, GPS data, and other sensor data (e.g., raw data) from one or more AVs 602, Unmanned Aerial Vehicles (UAVs), satellites, third-party mapping services, and other sources of geospatially referenced data. The raw data can be processed, and map management platform 662 can render base representations (e.g., tiles (2D), bounding volumes (3D), etc.) of the AV geospatial data to enable users to view, query, label, edit, and otherwise interact with the data. Map management platform 662 can manage workflows and tasks for operating on the AV geospatial data. Map management platform 662 can control access to the AV geospatial data, including granting or limiting access to the AV geospatial data based on user-based, role-based, group-based, task-based, and other attribute-based access control mechanisms. Map management platform 662 can provide version control for the AV geospatial data, such as to track specific changes that (human or machine) map editors have made to the data and to revert changes when necessary. Map management platform 662 can administer release management of the AV geospatial data, including distributing suitable iterations of the data to different users, computing devices, AVs, and other consumers of HD maps. Map management platform 662 can provide analytics regarding the AV geospatial data and related data, such as to generate insights relating to the throughput and quality of mapping tasks.

In some embodiments, the map viewing services of map management platform 662 can be modularized and deployed as part of one or more of the platforms and systems of the data center 650. For example, the AI/ML platform 654 may incorporate the map viewing services for visualizing the effectiveness of various object detection or object classification models, the simulation platform 656 may incorporate the map viewing services for recreating and visualizing certain driving scenarios, the remote assistance platform 658 may incorporate the map viewing services for replaying traffic incidents to facilitate and coordinate aid, the ridesharing platform 660 may incorporate the map viewing services into the client application 672 to enable passengers to view the AV 602 in transit en route to a pick-up or drop-off location, and so on.

### Example of a Computing System for a Scene Change Reaction Module

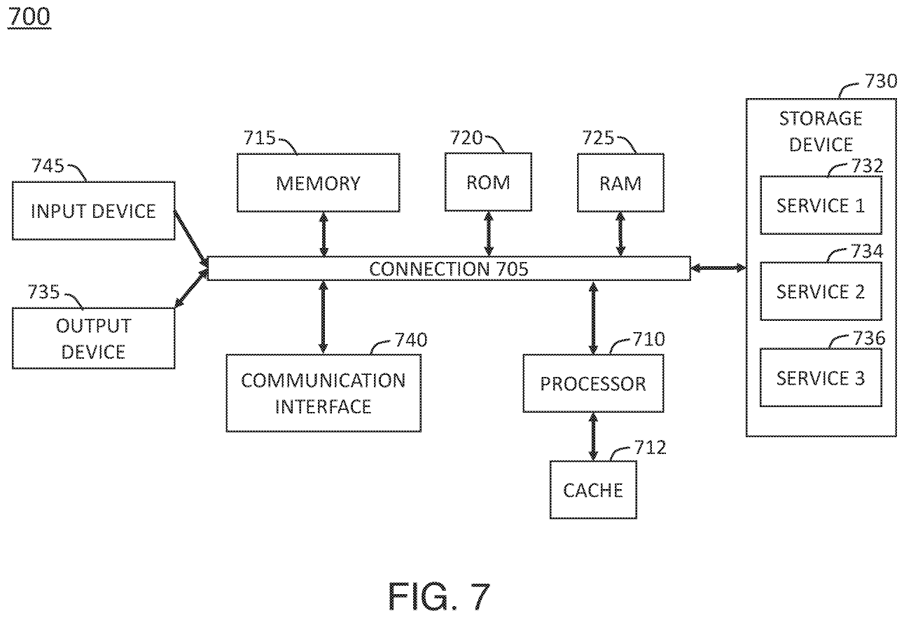

FIG. 7 shows an example embodiment of a computing system 700 for implementing certain aspects of the present technology. In various examples, the computing system 700 can be any computing device making up the onboard computer 104, the central computer 502, or any other computing system described herein. The computing system 700 can include any component of a computing system described herein which the components of the system are in communication with each other using connection 705. The connection 705 can be a physical connection via a bus, or a direct connection into processor 710, such as in a chipset architecture. The connection 705 can also be a virtual connection, networked connection, or logical connection.

In some implementations, the computing system 700 is a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices. For example, the components can include a simulation system, an artificial intelligence system, a machine learning system, and/or a neural network.

The example system 700 includes at least one processing unit (central processing unit (CPU) or processor) 710 and a connection 705 that couples various system components including system memory 715, such as read-only memory (ROM) 720 and random access memory (RAM) 725 to processor 710. The computing system 700 can include a cache of high-speed memory 712 connected directly with, in close proximity to, or integrated as part of the processor 710.

The processor 710 can include any general-purpose processor and a hardware service or software service, such as services 732, 734, and 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric. In some examples, a service 732, 734, 736 is a scene change reaction module, and is configured to detect environmental changes and identify scene changes that render a stop location unsatisfactory. The scene change reaction module can include a machine learning model for identifying scene changes that render a stop location unsatisfactory based on perceived features.

To enable user interaction, the computing system 700 includes an input device 745, which can represent any number of input mechanisms, such as a microphone for speech, a touch-sensitive screen for gesture or graphical input, keyboard, mouse, motion input, speech, etc. The computing system 700 can also include an output device 735, which can be one or more of a number of output mechanisms known to those of skill in the art. In some instances, multimodal systems can enable a user to provide multiple types of input/output to communicate with the computing system 700. The computing system 700 can include a communications interface 740, which can generally govern and manage the user input and system output. There is no restriction on operating on any particular hardware arrangement, and therefore the basic features here may easily be substituted for improved hardware or firmware arrangements as they are developed.

A storage device 730 can be a non-volatile memory device and can be a hard disk or other types of computer-readable media which can store data that are accessible by a computer, such as magnetic cassettes, flash memory cards, solid state memory devices, digital versatile disks, cartridges, RAMs, ROMs, and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as a processor 710, a connection 705, an output device 735, etc., to carry out the function.

In various implementations, the routing coordinator is a remote server or a distributed computing system connected to the autonomous vehicles via an Internet connection. In some implementations, the routing coordinator is any suitable computing system. In some examples, the routing coordinator is a collection of autonomous vehicle computers working as a distributed system.

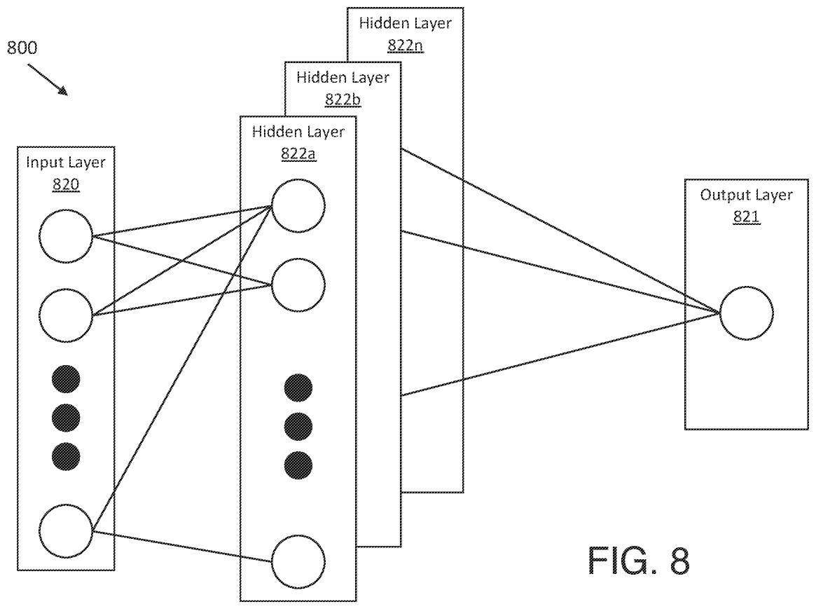

In FIG. 8, the disclosure now turns to a further discussion of models that can be used through the environments and techniques described herein. Specifically, FIG. 8 is an illustrative example of a deep learning neural network 800 that can be used to implement all or a portion of a perception module (or perception system) as discussed above. An input layer 820 can be configured to receive sensor data and/or data relating to an environment surrounding an autonomous vehicle, including scene changes. The neural network 800 includes multiple hidden layers 822a, 822b, through 822n. The hidden layers 822a, 822b, through 822n include “n” number of hidden layers, where “n” is an integer greater than or equal to one. The number of hidden layers can be made to include as many layers as needed for the given application. The neural network 700 further includes an output layer 821 that provides an output resulting from the processing performed by the hidden layers 822a, 822b, through 822n. In one illustrative example, the output layer 821 can provide various environmental change parameters, that can be used/ingested by a differential simulator to estimate a scene change rating indicating the likelihood that of a scene change.

The neural network 800 is a multi-layer neural network of interconnected nodes. Each node can represent a piece of information. Information associated with the nodes is shared among the different layers and each layer retains information as information is processed. In some cases, the neural network 800 can include a feed-forward network, in which case there are no feedback connections where outputs of the network are fed back into itself. In some cases, the neural network 800 can include a recurrent neural network, which can have loops that allow information to be carried across nodes while reading in input.

Information can be exchanged between nodes through node-to-node interconnections between the various layers. Nodes of the input layer 820 can activate a set of nodes in the first hidden layer 822a. For example, as shown, each of the input nodes of the input layer 820 is connected to each of the nodes of the first hidden layer 822a. The nodes of the first hidden layer 822a can transform the information of each input node by applying activation functions to the input node information. The information derived from the transformation can then be passed to and can activate the nodes of the next hidden layer 822b, which can perform their own designated functions. Example functions include convolutional, up-sampling, data transformation, and/or any other suitable functions. The output of the hidden layer 822b can then activate nodes of the next hidden layer, and so on. The output of the last hidden layer 822n can activate one or more nodes of the output layer 821, at which an output is provided. In some cases, while nodes in the neural network 800 are shown as having multiple output lines, a node can have a single output and all lines shown as being output from a node represent the same output value.

In some cases, each node or interconnection between nodes can have a weight that is a set of parameters derived from the training of the neural network 800. Once the neural network 800 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 800 to be adaptive to inputs and able to learn as more and more data is processed.

The neural network 800 is pre-trained to process the features from the data in the input layer 820 using the different hidden layers 822a, 822b, through 822n in order to provide the output through the output layer 821.

In some cases, the neural network 800 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 800 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target−output)²). The loss can be set to be equal to the value of E_total.

The loss (or error) will be high for the initial training data since the actual values will be much different than the predicted output. The goal of training is to minimize the amount of loss so that the predicted output is the same as the training output. The neural network 800 can perform a backward pass by determining which inputs (weights) most contributed to the loss of the network, and can adjust the weights so that the loss decreases and is eventually minimized.

The neural network 800 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 800 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

### SELECT EXAMPLES

Example 1 provides a system for vehicle reaction to a scene change, comprising: a ridehail application configured to transmit a ride request including a destination; a central computer configured to: receive the ride request from the ridehail application, determine a first stop location based on the destination, transmit the first stop location to the ridehail application, and transmit the ride request including the first stop location to a vehicle; and the vehicle, including: a sensor suite including a plurality of sensors configured to perceive an environment around the vehicle and generate sensor data; a map database including a map of an area including the first stop location; a scene change reaction module configured to: receive the sensor data, identify a scene change in the environment after an end of a first vehicle route, determine that the scene change renders the first stop location unsatisfactory, utilize the map of the area including the first stop location to identify alternative stopping locations; identify a second stop location in close proximity to the first stop location, wherein the second stop location is satisfactory; and an onboard computer configured to: generate the first vehicle route to the first stop location, control the vehicle to autonomously drive the vehicle to the first stop location and to stop at the first stop location at the end of the first vehicle route, receive the second stop location from the scene change reaction module, generate a second vehicle route from the first stop location to the second stop location, and control the vehicle to autonomously drive the vehicle to the second stop location.

Example 2 provides a method, system, and/or vehicle according to one or more of the preceding and/or following examples, wherein the scene change reaction module is further configured to identify the second stop location based, in part, on the destination.

Example 3 provides a method, system, and/or vehicle according to one or more of the preceding and/or following examples, wherein the onboard computer is further configured to transmit the second stop location to the central computer, and the central computer is further configured to transmit the second stop location to the ridehail application.

Example 4 provides a method, system, and/or vehicle according to one or more of the preceding and/or following examples, wherein the ridehail application is further configured to: receive the first stop location from the central computer, present the first stop location to a user interface, receive the second stop location from the central computer, and present the second stop location to the user interface.

Example 5 provides a method, system, and/or vehicle according to one or more of the preceding and/or following examples, wherein the plurality of sensors is a plurality of exterior sensors, wherein the vehicle further comprises a plurality of interior sensors configured to generate vehicle cabin sensor data, and wherein the onboard computer is further configured to: receive the vehicle cabin sensor data, determine, based on the vehicle cabin sensor data, there is a passenger inside the vehicle, and determine, based on the vehicle cabin sensor data, a passenger seatbelt is fastened.

Example 6 provides a method, system, and/or vehicle according to one or more of the preceding and/or following examples, wherein the onboard computer is further configured to: receive the sensor data, detect a user approaching the vehicle, and determine, based on a user location of the user, when to control the vehicle to autonomously drive the vehicle to the second stop location.

Example 7 provides a method, system, and/or vehicle according to one or more of the preceding and/or following examples, wherein the scene change includes the arrival of an emergency vehicle.

Example 8 provides a vehicle for reaction to a scene change at a first stop location, comprising: a sensor suite including a plurality of sensors configured to perceive an environment around the vehicle and generate sensor data; a map database including a map of an area including a first stop location; a scene change reaction module configured to: receive the sensor data, identify a scene change in the environment after an end of a vehicle route, determine that the scene change renders the first stop location unsatisfactory, utilize the map of the area including the first stop location to identify alternative stopping locations; identify a second stop location in close proximity to the first stop location, wherein the second stop location is satisfactory; and an onboard computer configured to: receive the second stop location, and control the vehicle to autonomously drive the vehicle to the second stop location.

Example 9 provides a method, system, and/or vehicle according to one or more of the preceding and/or following examples, wherein the onboard computer is further configured to: receive a ride request wherein the ride request includes a destination, identify the first stop location, wherein the first stop location is based on the destination, and generate a first vehicle route to the first stop location.

Example 10 provides a method, system, and/or vehicle according to one or more of the preceding and/or following examples, wherein the scene change reaction module is further configured to identify the second stop location based, in part, on the destination.

Example 11 provides a method, system, and/or vehicle according to one or more of the preceding and/or following examples, wherein the second stop location is within a one block radius of the first stop location.

Example 12 provides a method, system, and/or vehicle according to one or more of the preceding and/or following examples, wherein the onboard computer is further configured to determine there is a passenger inside the vehicle and determine the passenger is secured inside the vehicle.

Example 13 provides a method, system, and/or vehicle according to one or more of the preceding and/or following examples, wherein the onboard computer is further configured to determine that a user is approaching the vehicle.

Example 14 provides a method, system, and/or vehicle according to one or more of the preceding and/or following examples, wherein the scene change reaction module is further configured to determine that the vehicle is awaiting a new waypoint destination.

Example 15 provides a method for vehicle reaction to a scene change, comprising: stopping an autonomous vehicle at a first stop location at an end of a first vehicle route; perceiving an environment around the autonomous vehicle at the first stop location after the end of the first vehicle route; identifying a scene change in the environment after the end of the first vehicle route; determining that the scene change renders the first stop location unsatisfactory; identifying a second stop location, wherein the second stop location is satisfactory, and wherein the second stop location is in close proximity to the first stop location; and driving the autonomous vehicle to the second stop location, wherein driving the vehicle includes driving the vehicle without beginning a second vehicle route, and wherein an onboard computer on the autonomous vehicle controls the autonomous vehicle to cause the autonomous vehicle to drive to the second stop location.

Example 16 provides a method, system, and/or vehicle according to one or more of the preceding and/or following examples, wherein stopping the autonomous vehicle includes stopping the vehicle for one of passenger drop-off, passenger pick-up, delivery pick-up, and delivery drop-off.

Example 17 provides a method, system, and/or vehicle according to one or more of the preceding and/or following examples, wherein identifying the second stop location in close proximity to the first stop location comprises identifying the second stop location within a one block radius of the first stop location.

Example 18 provides a method, system, and/or vehicle according to one or more of the preceding and/or following examples, further comprising determining that the autonomous vehicle is awaiting a new waypoint destination.

Example 19 provides a method, system, and/or vehicle according to one or more of the preceding and/or following examples, wherein determining that the scene change renders the first stop location unsatisfactory includes identifying a request from another vehicle that the autonomous vehicle move from the first stop location, wherein identifying a request includes identifying at least one of a visual indication and an audio indication.

Example 20 provides a method, system, and/or vehicle according to one or more of the preceding and/or following examples, wherein identifying a second stop location includes requesting a second stop location from a central computer.

Example 21 provides a system for vehicle reaction to a scene change, comprising: a ridehail application configured to transmit a ride request including a destination; a central computer configured to: receive the ride request from the ridehail application, determine a first stop location based on the destination, transmit the first stop location to the ridehail application, and transmit the ride request including the first stop location to a vehicle; and the vehicle, including: a sensor suite including a plurality of sensors configured to perceive an environment around the vehicle and generate sensor data; a scene change reaction module configured to: receive the sensor data, identify a scene change in the environment after an end of a first vehicle route based on the sensor data, determine that the scene change renders the first stop location unsatisfactory, and communicate with the central computer to request a new stop location; and an onboard computer configured to: generate the first vehicle route to the first stop location, control the vehicle to autonomously drive the vehicle to the first stop location and to stop at the first stop location at the end of the first vehicle route; wherein the central computer is further configured to utilize a map of the area including the first stop location to identify alternative stopping locations, identify a new stop location in proximity to the first stop location, and transmit the new stop location to the scene change reaction module; wherein the onboard computer receives the new stop location from the scene change reaction module, generates a second vehicle route from the first stop location to the new stop location, and controls the vehicle to autonomously drive the vehicle to the new stop location.

Example 22 provides a method, system, and/or vehicle according to one or more of the preceding and/or following examples, wherein the scene change reaction module is further configured to receive the new stop location from the central computer and determine that the new stop location is satisfactory.

Example 23 provides a vehicle for reaction to a scene change at a first stop location, comprising: a sensor suite including a plurality of sensors configured to perceive an environment around the vehicle and generate sensor data; a map database including a map of an area including a first stop location; a scene change reaction module configured to: receive the sensor data, identify a scene change in the environment after an end of a vehicle route based on the sensor data, determine that the scene change renders the first stop location unsatisfactory, request a new stop location from a central computer, receive the new stop location from the central computer, and determine that the new stop location is satisfactory; and an onboard computer configured to: receive the new stop location, and control the vehicle to autonomously drive the vehicle to the second stop location.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A system for vehicle reaction to a scene change, comprising:
a ridehail application configured to transmit a ride request including a destination;
a central computer configured to:
receive the ride request from the ridehail application,
determine a first stop location based on the destination,
transmit the first stop location to the ridehail application, and
transmit the ride request including the first stop location to a vehicle; and
the vehicle, including:
a sensor suite including a plurality of sensors configured to perceive an environment around the vehicle and generate sensor data;
a map database including a map of an area including the first stop location;
a scene change reaction module configured to:
receive the sensor data,
identify a scene change in the environment after an end of a first vehicle route based on the sensor data,
determine that the scene change renders the first stop location unsatisfactory,
utilize the map of the area including the first stop location to identify alternative stopping locations, and
identify a second stop location in proximity to the first stop location, wherein the second stop location is satisfactory; and
an onboard computer configured to:
generate the first vehicle route to the first stop location,
control the vehicle to autonomously drive the vehicle to the first stop location and to stop at the first stop location at the end of the first vehicle route,
receive the second stop location from the scene change reaction module,
generate a second vehicle route from the first stop location to the second stop location, and
control the vehicle to autonomously drive the vehicle to the second stop location.

2. The system of claim 1, wherein the scene change reaction module is further configured to identify the second stop location based, in part, on the destination.

3. The system of claim 2, wherein the onboard computer is further configured to transmit the second stop location to the central computer, and the central computer is further configured to transmit the second stop location to the ridehail application.

4. The system of claim 3, wherein the ridehail application is further configured to:
receive the first stop location from the central computer,
present the first stop location to a user interface,
receive the second stop location from the central computer, and
present the second stop location to the user interface.

5. The system of claim 4, wherein the plurality of sensors is a plurality of exterior sensors, wherein the vehicle further comprises a plurality of interior sensors configured to generate vehicle cabin sensor data, and wherein the onboard computer is further configured to:
receive the vehicle cabin sensor data,
determine, based on the vehicle cabin sensor data, there is a passenger inside the vehicle, and
determine, based on the vehicle cabin sensor data, a passenger seatbelt is fastened.

6. The system of claim 4, wherein the onboard computer is further configured to:
receive the sensor data,
detect a user approaching the vehicle, and
determine, based on a user location of the user, when to control the vehicle to autonomously drive the vehicle to the second stop location.

7. The system of claim 1, wherein the scene change includes the arrival of an emergency vehicle.

8. A vehicle for reaction to a scene change at a first stop location, comprising:
a sensor suite including a plurality of sensors configured to perceive an environment around the vehicle and generate sensor data;
a map database including a map of an area including a first stop location;
a scene change reaction module configured to:
receive the sensor data,
identify a scene change in the environment after an end of a vehicle route based on the sensor data,
determine that the scene change renders the first stop location unsatisfactory,
utilize the map of the area including the first stop location to identify alternative stopping locations, and
identify a second stop location in proximity to the first stop location, wherein the second stop location is satisfactory; and
an onboard computer configured to:
receive the second stop location, and
control the vehicle to autonomously drive the vehicle to the second stop location.

9. The vehicle of claim 8, wherein the onboard computer is further configured to:
receive a ride request wherein the ride request includes a destination,
identify the first stop location, wherein the first stop location is based on the destination, and
generate a first vehicle route to the first stop location.

10. The vehicle of claim 9, wherein the scene change reaction module is further configured to identify the second stop location based, in part, on the destination.

11. The vehicle of claim 10, wherein the second stop location is within a one block radius of the first stop location.

12. The vehicle of claim 8, wherein the onboard computer is further configured to determine there is a passenger inside the vehicle and determine the passenger is secured inside the vehicle.

13. The vehicle of claim 8, wherein the onboard computer is further configured to determine that a user is approaching the vehicle.

14. The vehicle of claim 8, wherein the scene change reaction module is further configured to determine that the vehicle is awaiting a new waypoint destination.

15. A method for vehicle reaction to a scene change, comprising:
stopping an autonomous vehicle at a first stop location at an end of a first vehicle route;
perceiving an environment around the autonomous vehicle at the first stop location after the end of the first vehicle route;
identifying a scene change in the environment after the end of the first vehicle route;
determining that the scene change renders the first stop location unsatisfactory;
identifying a second stop location, wherein the second stop location is satisfactory, and wherein the second stop location is in proximity to the first stop location; and
driving the autonomous vehicle to the second stop location, wherein driving the vehicle includes driving the vehicle without beginning a second vehicle route, and wherein an onboard computer on the autonomous vehicle controls the autonomous vehicle to cause the autonomous vehicle to drive to the second stop location.

16. The method of claim 15, wherein stopping the autonomous vehicle includes stopping the vehicle for one of passenger drop-off, passenger pick-up, delivery pick-up, and delivery drop-off.

17. The method of claim 16, wherein identifying the second stop location in close proximity to the first stop location comprises identifying the second stop location within a one block radius of the first stop location.

18. The method of claim 15, further comprising determining that the autonomous vehicle is awaiting a new waypoint destination.

19. The method of claim 18, wherein determining that the scene change renders the first stop location unsatisfactory includes identifying a request from another vehicle that the autonomous vehicle move from the first stop location, wherein identifying a request includes identifying at least one of a visual indication and an audio indication.

20. The method of claim 19, wherein identifying a second stop location includes requesting a second stop location from a central computer.
